(19) United States
(12) Patent Application Publication
(10) Pub. No.: US 2015/0227828 A1
(43) Pub. Date: Aug. 13, 2015

(54) CONTACTLESS PAYMENT INTEGRATED IN COSMETIC PACKAGING

(71) Applicant: HCT Group Holdings Limited, Central (HK)

(72) Inventors: CHRISTOPHER ANTHONY NIBLETT, London (GB); Armando Villarreal, Los Angeles, CA (US)

(21) Appl. No.: 14/618,673

(22) Filed: Feb. 10, 2015

Related U.S. Application Data
(60) Provisional application No. 61/937,887, filed on Feb. 10, 2014.
(60) Provisional application No. 61/974,928, filed on Apr. 3, 2014.

(51) Int. Cl. G06K 19/077

(52) U.S. Cl. CPC G06K 19/07745; G06K 19/07749

(57) ABSTRACT

A contactless payment chip is integrated in cosmetic packaging for a cosmetic product. The chip integrated in the cosmetic packaging allows for various transactions as capable by any contactless chip and associated system. In some embodiments, the contactless payment chip is removable. A plug or tray may be configured to removably snap, slide, twist, or otherwise be inserted into a corresponding recess of a cosmetic packaging. In other embodiments, the contactless payment chip is non-removable and is embedded or molded into a portion of the cosmetic packaging. Depending on the type of cosmetic packaging, the chip may be positioned in various locations, such as a base portion, a lid portion, a cap, or a side recess.

### CROSS REFERENCE TO RELATED APPLICATIONS

This application claims priority to U.S. Provisional Patent Application No. 61/937,887, filed on Feb. 10, 2014, and U.S. Provisional Patent Application No. 61/974,928, filed on Apr. 3, 2014, each of which is hereby incorporated by reference in its entirety herein.

### TECHNOLOGY FIELD

This disclosure relates generally to contactless payment devices, and more particularly to integrating a contactless payment form into cosmetic packaging and products.

### BACKGROUND

Contactless payment systems allow for payment or other transactions by a user utilizing a device or product containing a chip and, optionally, an antenna. A reader receives signals from the chip when the device or product is moved near to the reader, and the reader is configured to process various transactions according to information contained on the chip.

Contactless payment systems are becoming more widespread due to their ease of use, convenience, and security features. Moreover, in addition to acting as a form of payment, there are various other advantageous features available through a contactless payment system, such as incentive programs, gift card programs, ticketing applications, security, and the like. Several major credit card companies have contactless payment initiatives with leading banks, and numerous retailers have installed and integrated contactless payment readers.

While contactless payment chips are found embedded in credit or debit cards, smart cards, key fobs, and some everyday items (such as mobile devices, mobile device covers, and watches), they are not currently found in cosmetic packaging or products. However, it would be highly desirable to enable payment and other contactless transactions through cosmetic packaging and products, which is used and often carried by a large number of individuals.

### SUMMARY

Embodiments of the present invention provide for integrating contactless payment chips into cosmetic packaging and products.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIGS. 1A-1E illustrate integration of a contactless payment chip into compacts, according to several embodiments;

FIGS. 2A-2D illustrate integration of a contactless payment chip into lipsticks, according to several embodiments;

FIGS. 3A-3D illustrate integration of a contactless payment chip into cosmetic bottles, according to several embodiments;

FIGS. 4A-4C illustrate integration of a contactless payment chip into cosmetic tubes, according to several embodiments;

FIG. 5 illustrates integration of an antenna with a contactless payment chip into a compact, according to an embodiment; and

FIG. 6 illustrates integration of a contactless payment chip into cosmetic brushes, according to several embodiments.

FIG. 7 illustrates integration of a contactless payment chip into a cosmetic brush according to several embodiments.

FIG. 8 illustrates integration of a contactless payment chip into a bottle, such as a fragrance bottle, in accordance with several embodiments.

FIG. 9 depicts integration of a contactless payment chip into a pump mechanism in accordance with several embodiments.

FIG. 10 illustrates integration of a contactless payment chip into the outer shell of a container such as a fragrance bottle, in accordance with some embodiments.

FIG. 11 illustrates integration of a contactless payment chip into a hair brush in accordance with some embodiments.

FIG. 12 illustrates an alternative integration of a contactless payment chip into a hair brush in accordance with some embodiments.

### DETAILED DESCRIPTION

Contactless payment systems allow for payment by communication between a reader and a product containing a chip and, optionally, an antenna. Some systems operate through radio-frequency identification; the chip is comprised of integrated circuits that process and store data, communicating with the reader through radio waves. The embedded chip and antenna enable consumers to wave or otherwise move their product/device over a reader, and the reader processes data. Data relating to the contactless payment chip is transferred to a central administration system through the reader over a communication network (e.g., one or more of a wired and wireless network, such as the Internet and the like). The central administration system manages the data and other settings and configurations.

Some contactless payment chips contain memory storage components and/or a re-writeable microchip. A contactless payment chip may also contain logic relating to security, identification, authentication, and the like. Other possible features include a security system for providing tamper-resistance and other security services, such as information confidentiality.

According to embodiments, a contactless payment chip, which is well known and has some or all of the characteristics described above, is embedded and/or integrated in cosmetic packaging for a cosmetic product. In this manner, a user of the cosmetic packaging is able to, for example, transact payments or gain entry to various events or transportation modes without having to carry a separate wallet or payment card; instead, a lipstick, compact, or the like will suffice. In this way, a consumer can have the benefits of a traditional contactless payment system in the convenience of a cosmetic package such as a compact or lipstick, without needing to carry a wallet or credit card. The issuer can benefit from all the information available via the contactless payment system and network.

A compact may contain cosmetics or makeup in a traditional sense, but may also be a similarly designed container for housing applicators, blotting papers or other personal care items. As will be appreciated by those of skill in the art, the various containers, compacts, and other cosmetic packaging or products described herein can be made of any suitable material or combination of materials, such as plastic, metal, ceramic, wood, glass, paper, paperboard, and the like.

It is particularly contemplated that the contactless payment chip be configured to allow for a maximum monetary storage amount to minimize financial loss if misplaced or stolen. It is further contemplated that the cosmetic packaging with the contactless payment chip will perform similarly to a gift card, with the cosmetic product and chip being given to consumers to encourage brand loyalty.

It is further contemplated that the cosmetics company or the packaging company can establish a system within which the contactless payment chip works. The system can track a variety of information, including spending habits, locations, and usage, among other things. This will allow the chip issuer to tailor its marketing efforts based on the tracked information. These and other uses will be apparent to one of skill in the art based on this specification.

As used herein, cosmetic packaging refers to a container in which a cosmetic product is contained or housed. Types of containers may include, but are not limited to, compacts, tubes, bottles, tottles (a type of bottle that sits on its top or cap), twist/click pens, atomizers (a type of container with an atomizer nozzle for creating an aerosol spray or mist), and the like. In some embodiments, cosmetic packaging refers to removable portions of cosmetic packaging, such as cosmetic brushes, applicators, and the like; for example, a cosmetic brush for applying powder, blush, or bronzer.

As used herein, a cosmetic product refers to various types of cosmetics including, but not limited to, powder, blush, bronzer, eye shadow, lipstick, lip gloss, mascara, concealer, creams, lotions, fragrances, and the like.

According to embodiments, the chip is isolated from (i.e., not in contact with) the cosmetic product. For example, the chip is housed in a separate compartment and/or is sealed to prevent contact of the chip with the cosmetic product.

In some embodiments, the contactless payment chip is removable. For example, in one embodiment, a plug or tray may be configured to removably snap, slide, twist, friction fit, or otherwise be inserted into a corresponding recess of a cosmetic packaging. The plug or tray is sized and shaped to securely hold the contactless payment chip, while also preferably being of a size and shape convenient for a consumer to easily handle. Depending on the type of cosmetic packaging, the plug or tray may be positionable in various locations, such as, for example, a base or lid portion of a compact, lipstick, or pen product; or a cap of a bottle, tube, tottle, or atomizer. In other embodiments, a recess or slot may be provided in the cosmetic packaging for removably receiving a plug in, for example, a side or bottom portion of a lipstick, bottle, atomizer, or brush. In some embodiments, the contactless payment chip is placed in the recess or slot via an opening, and a plug or cover serves to hold the chip in place by covering the opening to the recess or slot. In some embodiments, the contactless payment chip may be embedded in a liner or inner portion of a cosmetic packaging with an exterior formed around the liner or inner portion. For example, an atomizer may be utilized for fragrances and the like, and may comprise an inner plastic liner in which the chip is embedded or molded in a bottom portion, a side portion, or in the sprayer. Glass or another material may surround the inner plastic liner. In other embodiments, the atomizer need not have a separate liner and exterior portion, and the contactless payment chip may be embedded in the bottle portion, a side portion, or the sprayer component of the atomizer. In other embodiments, a glass container, such as a bottle, may be provided with an outer liner of a different material, such as plastic. The contactless payment chip may be embedded in this outer liner as well. This option may be particularly well suited for glass bottles where it might be more difficult to embed a chip. The liner may be decorative and could completely surround the underlying container, or could be applied to only a portion of the underlying container, such as at the base, or around the neck.

According to some embodiments in which the contactless payment chip is removable, a sleeve, bracket, or the like may be utilized to hold the chip and removably attach to a portion of the cosmetic packaging. For example, a sleeve may be configured to removably surround a compact or a portion thereof, and a contactless payment chip may be molded or otherwise embedded within the sleeve, or held in a pocket or the like on the sleeve. In this way, a consumer may switch between like products (e.g., like-sized compacts) while still having the benefits of the contactless payment system if utilizing the sleeve. In other embodiments, a removable sleeve may be configured to wrap around a portion of a bottle or atomizer or a handle of a cosmetic brush. In some embodiments, the removable sleeve may be adjustable to accommodate various items, for example various sized bottles or cosmetic brushes. In some embodiments, the sleeve can be permanently adhered to the underlying device via adhesive, glue, etc. In other embodiments, the sleeve can be selectively removable and interchangeable with other products.

It may be desirable to some manufacturers and retailers to utilize a removable configuration of the contactless payment chip for security reasons. For example, a removable configuration allows for the chip to be placed in the product at a point-of-sale at the time of purchase; thus in instances when a certain dollar amount is already associated with the chip, the chip is only added upon purchase, alleviating theft concerns. The removable configuration is also desirable for a consumer to be able to place the chip in other products.

In other embodiments, the contactless payment chip is non-removable. In these embodiments, the cosmetic packaging may be designed and constructed so that the cosmetic portion itself is replaceable, thereby permitting continued the use of the packaging.

For either removable or non-removable contactless payment chips, the chip may be activated at the time of purchase, similar to the manner in which a gift card is activated upon purchase. In some embodiments, the chip may be activated online via a website, mobile application, or the like, after purchase of the cosmetic product. In other embodiments, the chip may be activated by calling a designated telephone number and following specific prompts for activation. In some embodiments, the chip may be activated at the point of sale (POS).

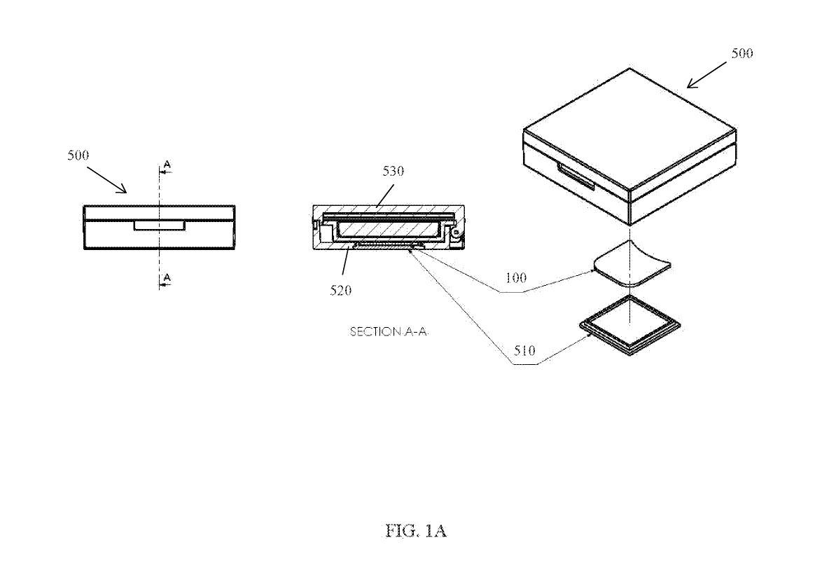

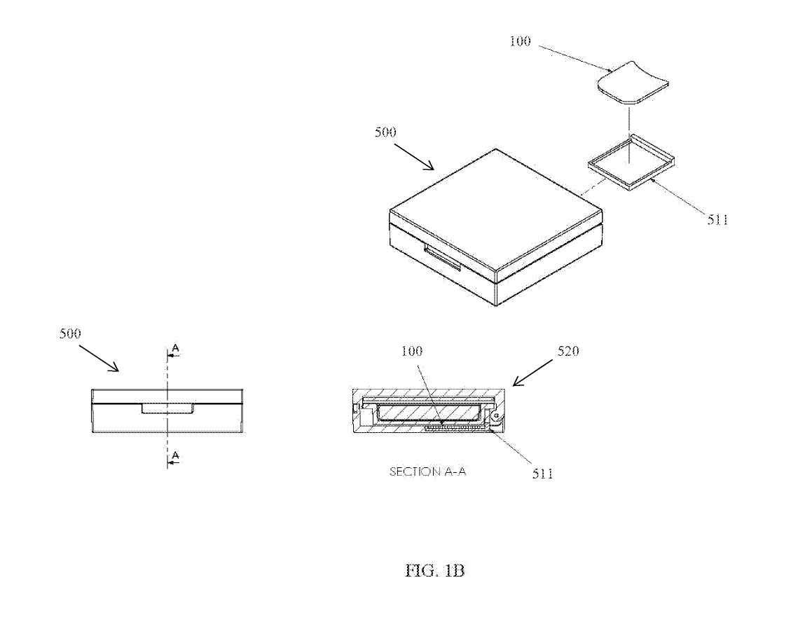

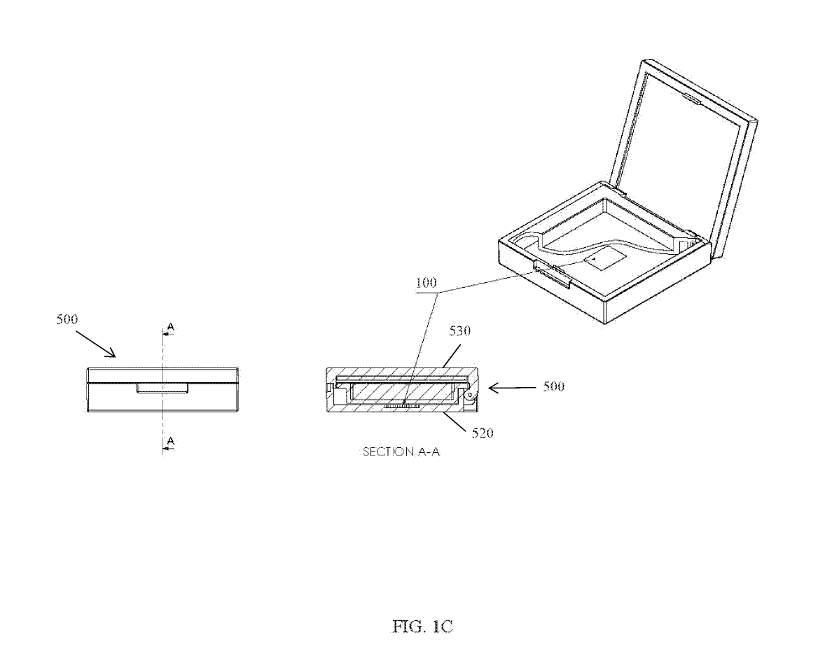

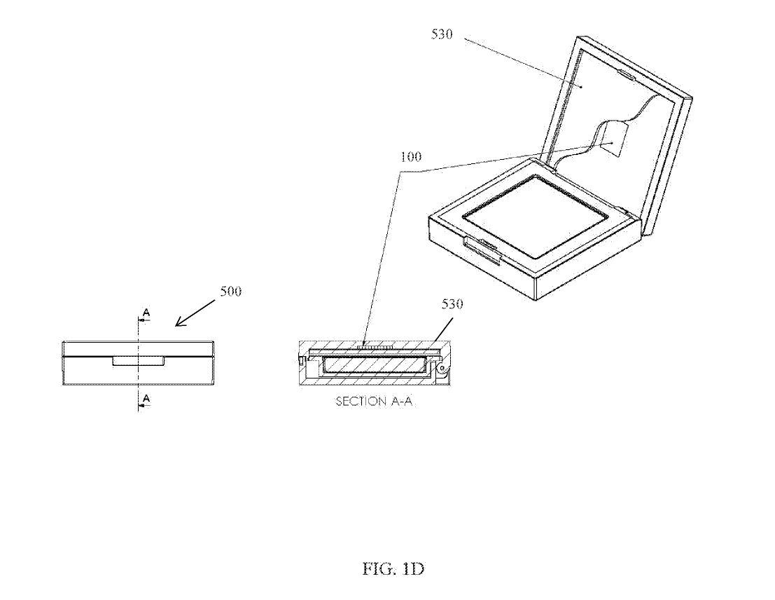

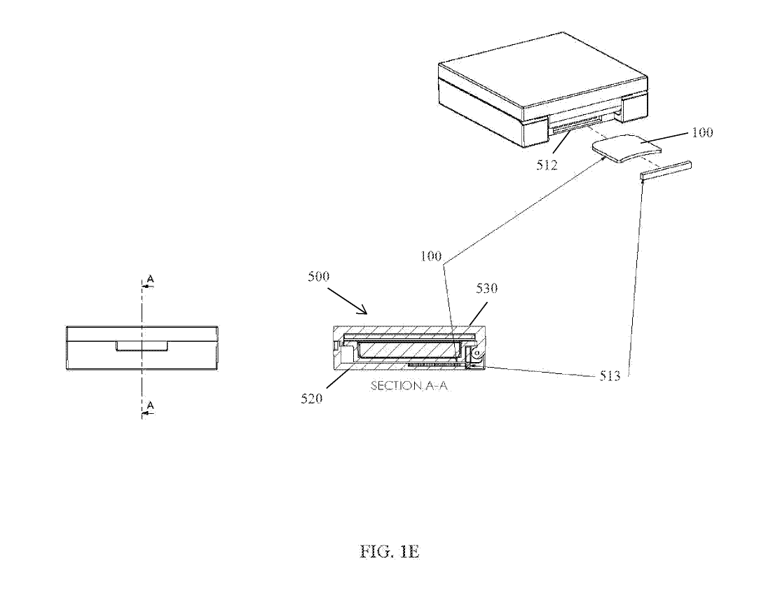

FIGS. 1A-1E illustrate integration of a contactless payment chip into compacts, according to several embodiments. The compacts may be used for powders, blushes, bronzers, eye shadows, and the like. FIG. 1A shows a compact 500 with a removable plug 510 configured to hold a contactless payment chip 100 and removably fit or snap into a bottom or base portion 520 of the compact. Alternatively, the plug 510 and chip 100 could be fitted similarly to any sidewall of the compact, such as the lid 530. FIG. 1B shows a compact with a removable tray configured to hold a contactless payment chip and removably fit or slide into a bottom or base portion of the compact. In other embodiments, a top or lid portion of the compact may be used with the plug style or the tray style. FIG. 1C illustrates a compact 500 with a non-removable configuration in which the chip 100 is molded or embedded (e.g., glued into a recess) in the base 520 of the compact, while FIG. 1D shows a similar configuration in the lid 530 of the compact 500. FIG. 1E shows a compact with a slot 512 formed into a portion of the compact 500, the slot 512 sized to hold a contactless payment chip 100. The chip 100 is secured in the compact 500 with a removable or non-removable plug 513 sized to cover the opening to the slot 512.

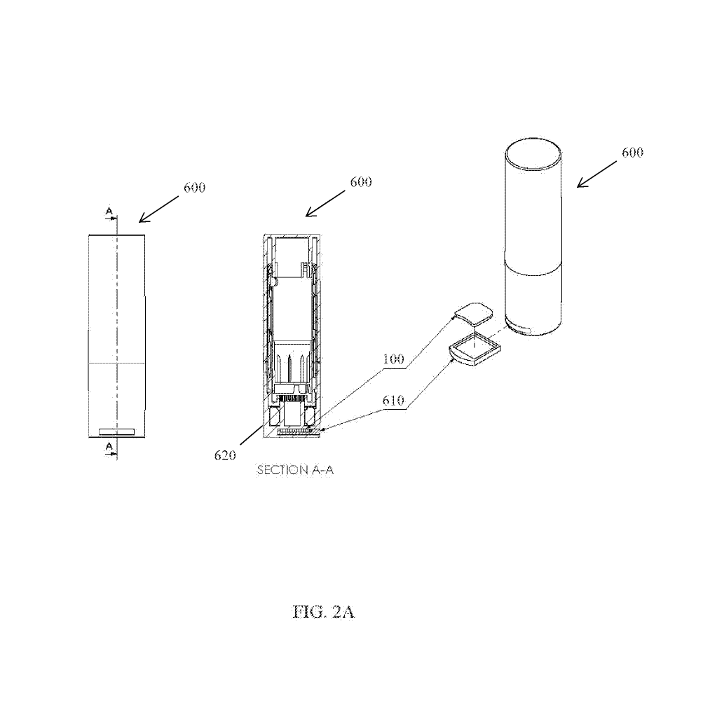

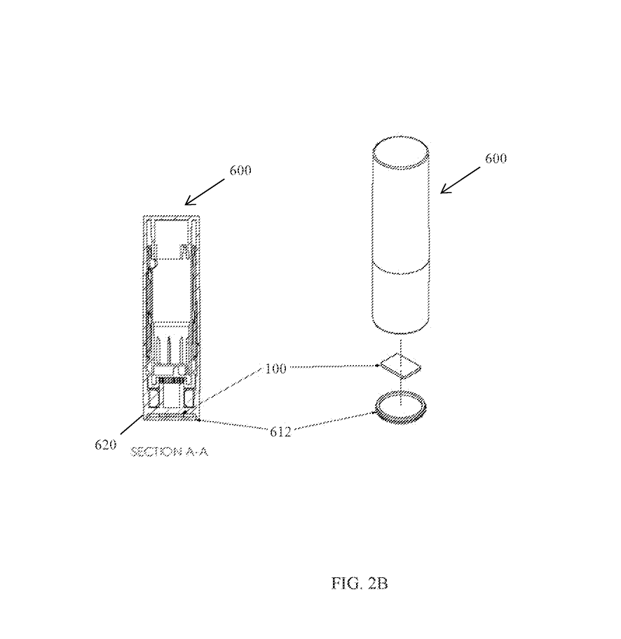

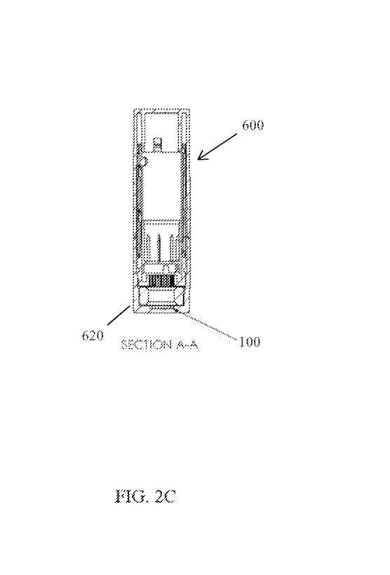

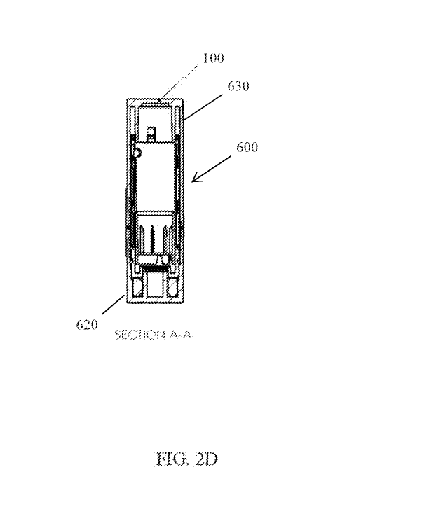

FIGS. 2A-2D illustrate integration of a contactless payment chip 100 into lipsticks 600, according to several embodiments. In the removable configurations of FIGS. 2A and 2B, a tray 610 and a plug 612, respectively, are configured to hold the contactless payment chip 100 and removably slide or snap into a bottom or base portion 620 of the lipstick. In other embodiments, the tray 610 and plug 612 can be configured into a top or cap portion of the lipstick. As shown in FIGS. 2C and 2D, the chip 100 may be molded (e.g., glued into a recess) in the base portion 620 and the cap portion 630, respectively, of the lipstick.

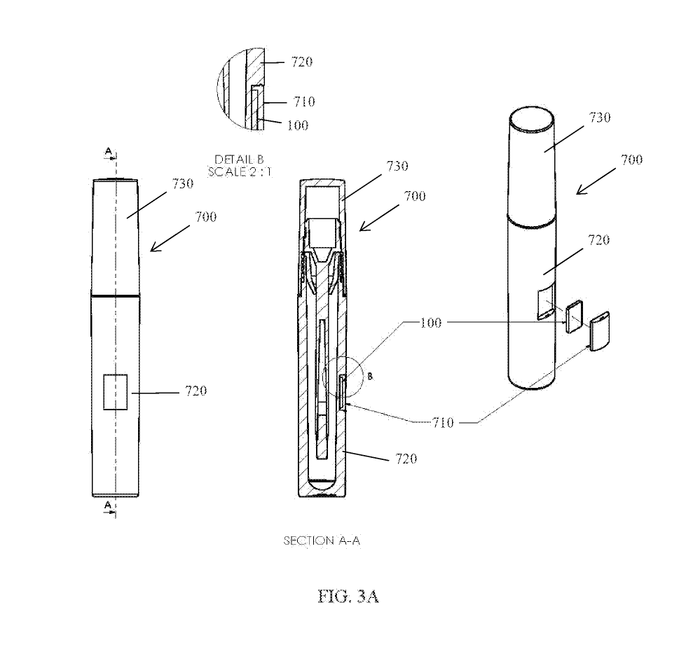

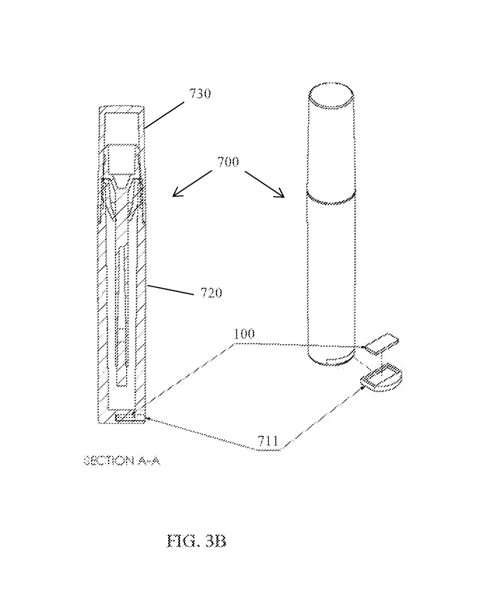

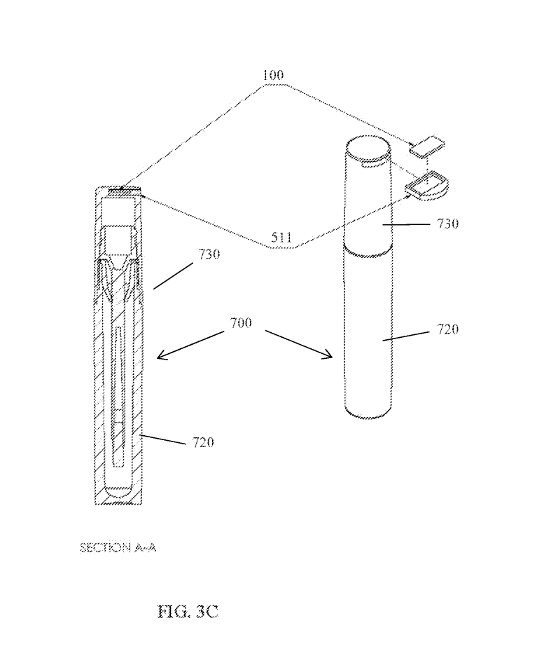

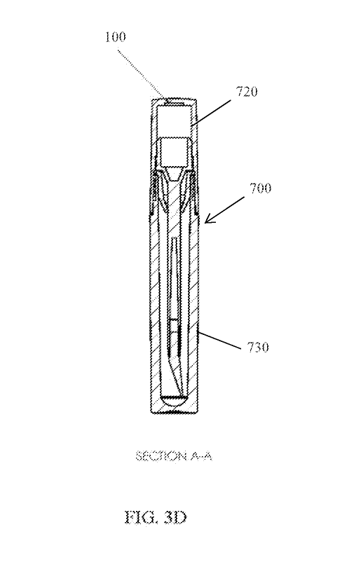

FIGS. 3A-3D illustrate integration of a contactless payment chip 100 into bottles 700, according to several embodiments. The bottles 700 may be used for lip gloss, mascara, liquid concealer, lip stain, fragrance, and the like. FIGS. 3A, 3B, and 3C illustrate removable configurations in which the chip 100 is contained into a side recess of a bottle 700 with a removable plug 710 (FIG. 3A), in a bottom portion 720 with a removable tray (FIG. 3B), or in a top or cap portion 730 with a removable tray 511 (FIG. 3C). A plug 512 style may also be used for the configurations in the bottom 720 or top portions 730. FIG. 3D illustrates a non-removable configuration in which the chip 100 is embedded in a top or cap portion 730 of a bottle. In this embodiment, the chip 100 may be molded into the cap or glued into a recess in the cap. In other non-removable configurations for bottles, the chip may also be embedded in a bottom or side recess. In such embodiments, the chip may be covered by a sticker or other covering.

In some embodiments, the various configurations for integrating a contactless payment chip into a bottle may apply for the integration of a chip into an atomizer.

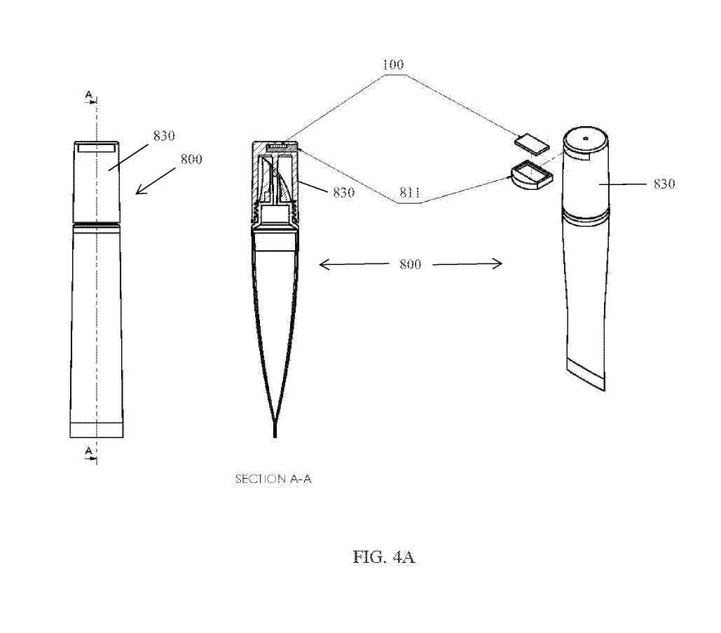

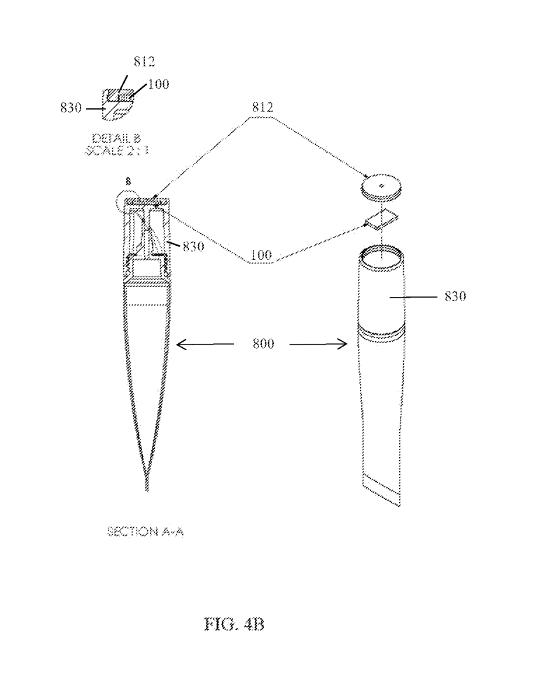

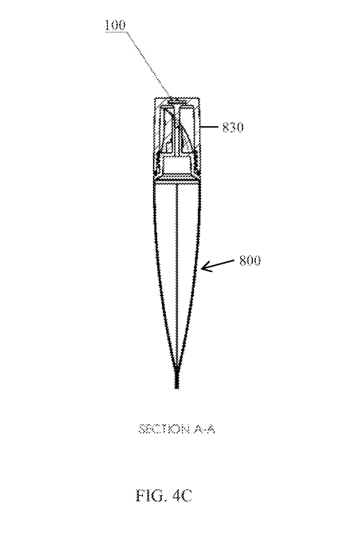

FIGS. 4A-4C illustrate integration of a contactless payment chip 100 into tubes 800, according to several embodiments. The tubes 800 may be used for lip gloss, eye cream, face cream, concealer, and the like. FIGS. 4A and 4B illustrate removable configurations utilizing a removable tray 811 insertable into a cap 830 of a tube for securing the chip 100 (FIG. 4A) and a removable plug 812 that fits into the cap 830 for securing the chip (FIG. 4B). FIG. 4C illustrates a non-removable configuration in which the chip 100 is embedded into a recess in the cap 830 of a tube.

In other embodiments, a chip may be contained with a removable tray or plug in a top or cap portion of a tottle, used for lip gloss, liquid concealer, lip stain, and the like. The chip may alternatively be embedded in a cap of a tottle in a non-removable configuration.

In yet another embodiment, a tray or plug may be used to removably hold a chip in a base or lid of a twist/click pen, used for lip gloss, liquid concealer, lip stain, skin treatment, and the like. In another embodiment, a plug may be used to cover an opening to a recess or slot that is configured to hold a chip in a bottom, top, or side portion of a cosmetic packaging. In a non-removable configuration, the chip may be embedded (e.g., molded or glued into a recess) in the base or lid of a twist/click pen.

In some embodiments, the cosmetic packaging may be metal or comprise metal. In some such embodiments, such metal may be operably coupled to the contactless payment chip to act as an antenna. In this way, signal strength may be improved.

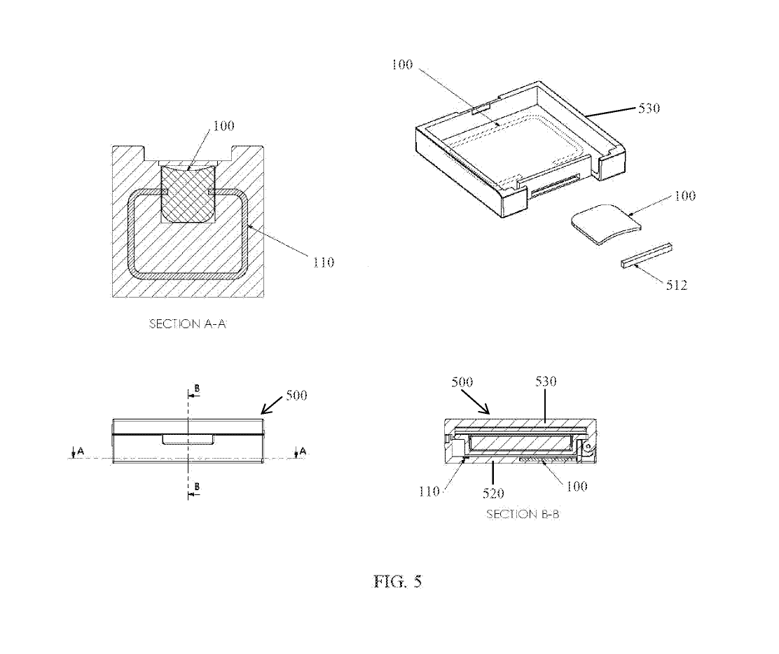

FIG. 5 illustrates incorporation of an antenna 110 with a contactless payment chip 100 in a compact 500, according to an embodiment. Incorporation of an antenna 100 may serve to improve signal strength for improved communication with a reader of the contactless payment system. As shown in FIG. 5, according to an embodiment, an antenna 110 may be molded or glued into a portion of a cosmetic packaging (in this case, a compact) and may connect to the chip 100 when the chip 100 is inserted or embedded in the packaging. Although shown in a compact 500, the incorporation of an antenna 110 is not so limited, and an antenna may be integrated in various cosmetic packaging to improve and/or enhance signal strength.

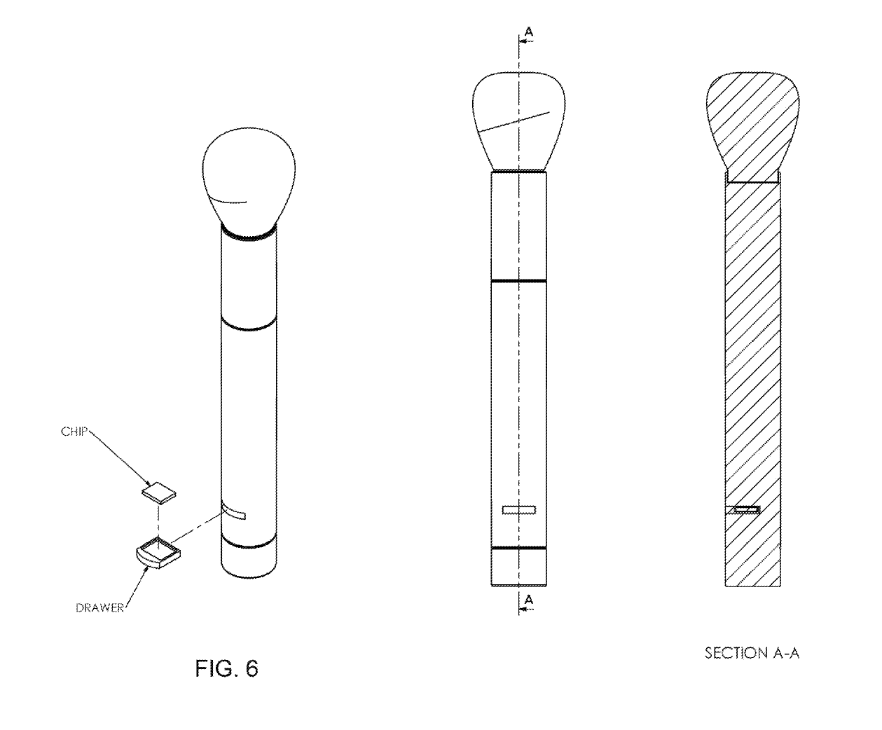

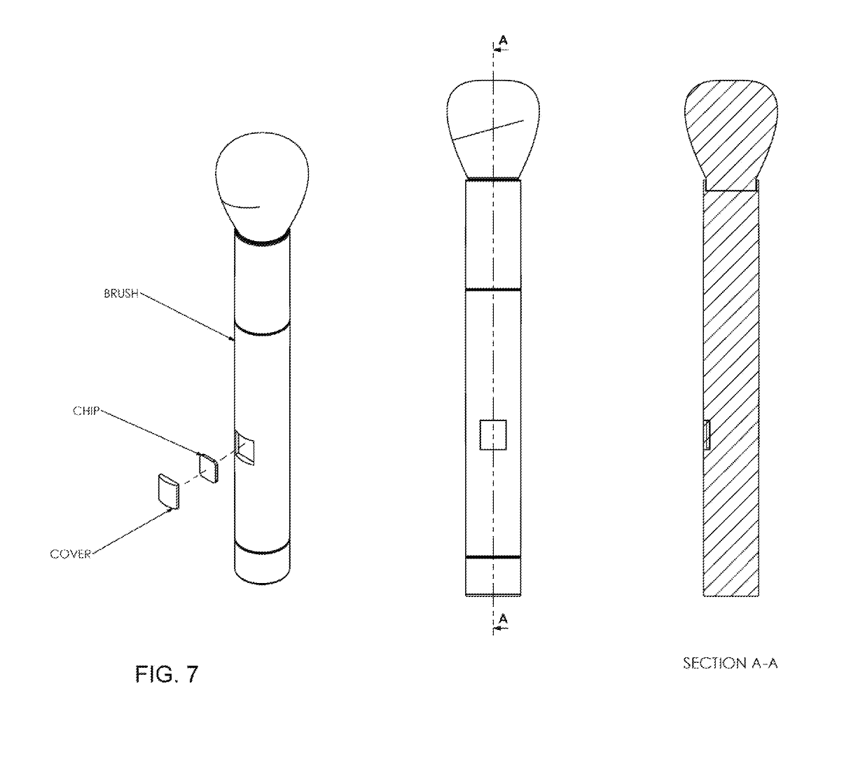

FIGS. 6 and 7 illustrate integration of a contactless payment chip into cosmetic brushes, according to several embodiments. In accordance with these embodiments, the handle portion of the brush defines a recess for accepting a contactless payment chip 100 by any of the mean disclosed herein, include a tray, a plug, slot, or embedded arrangement.

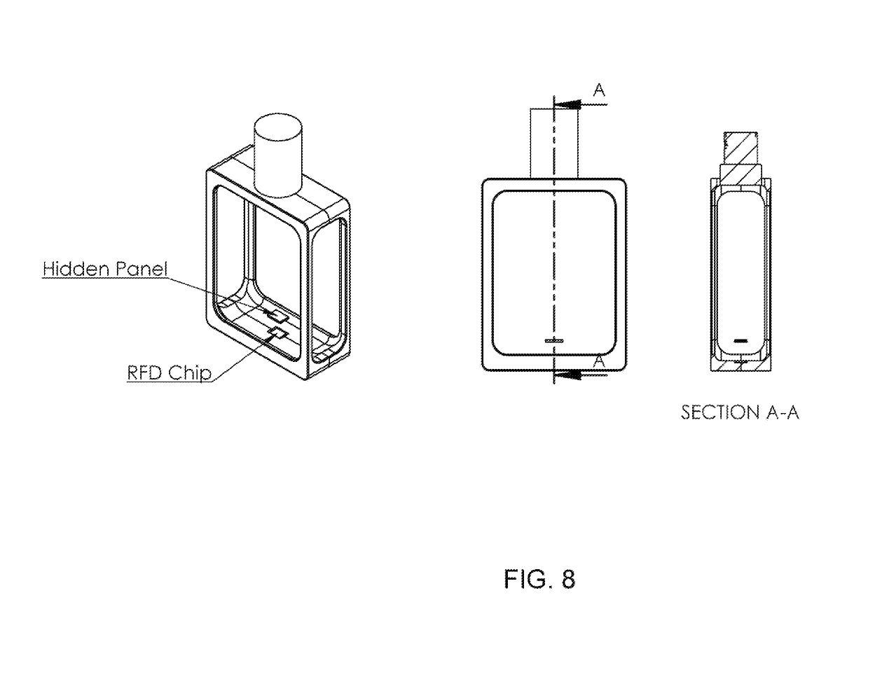

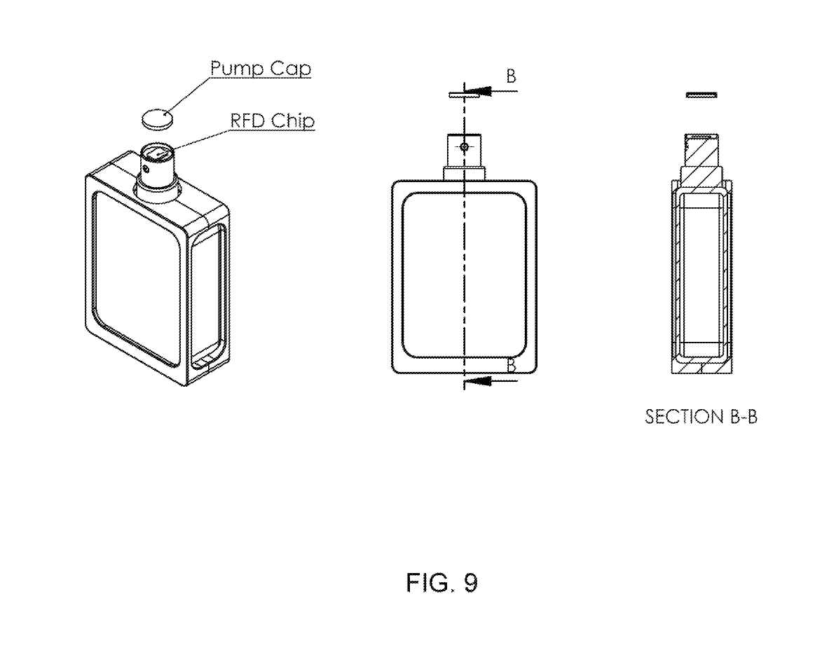

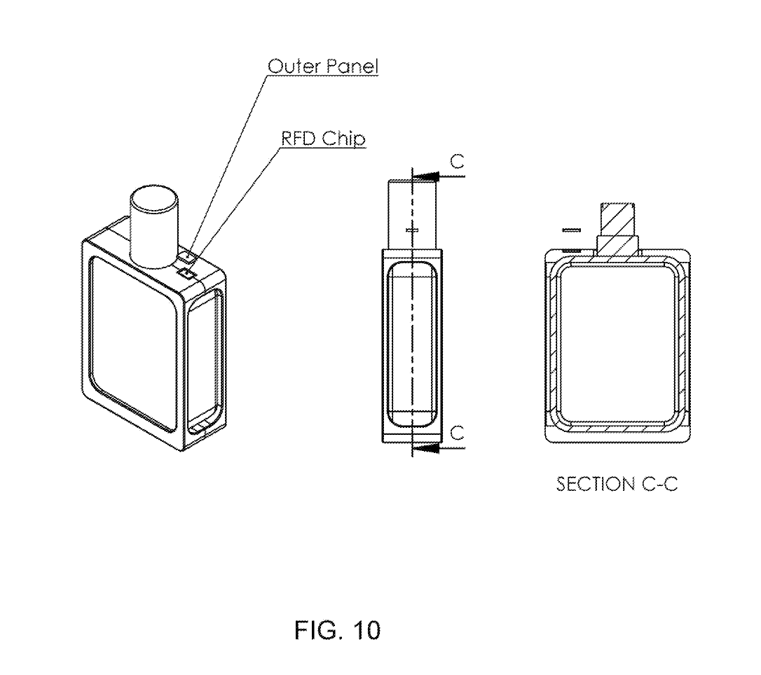

FIGS. 8-10 illustrate the use of the contactless payment chip in a bottle, such as a fragrance bottle. In some embodiments the chip can be placed in the sidewall (top, bottom, or sides, of the bottle. In some embodiments, such as shown in FIGS. 8 and 10, an encasing structure such as plastic, rubber, or other material may be provided for at least partially encapsulating the bottle and housing the chip. In some embodiments, such as shown in FIG. 9, the chip may be housed in the pump mechanism of a bottle. Any of the techniques discussed herein can be employed. In some instances, embedding the chip in the materials is most efficient, as the chip can be inserted during the molding or manufacturing process.

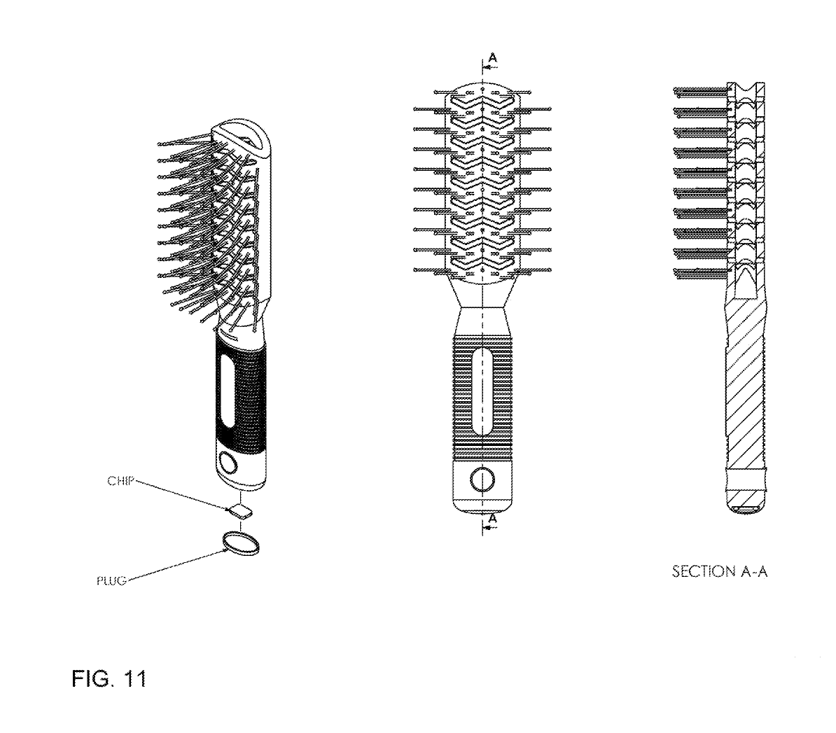

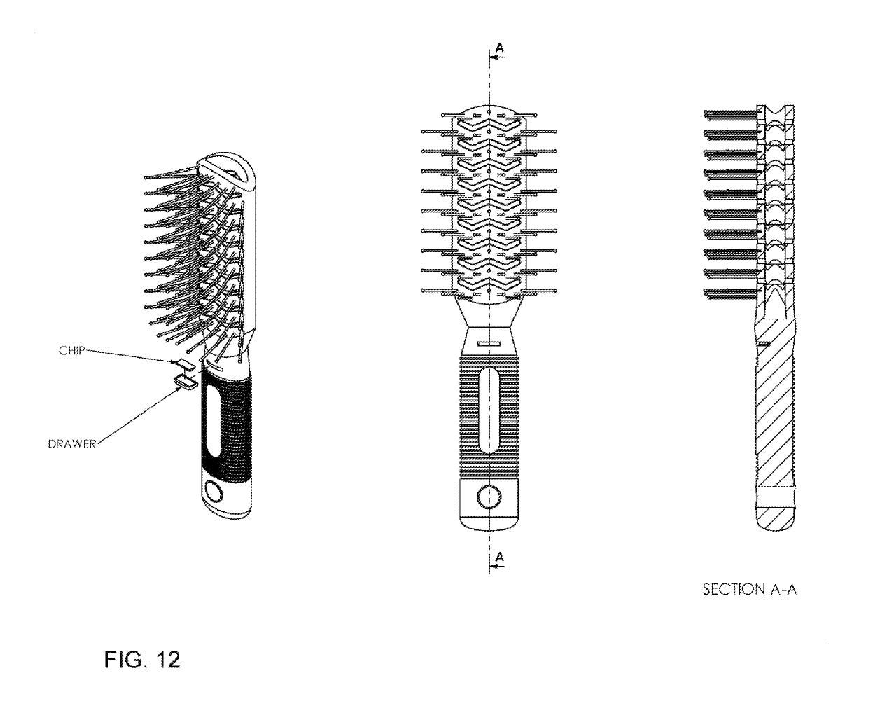

In other embodiments, such as shown in FIGS. 11 and 12, a contactless payment chip may be integrated in a hair brush or comb. Any of the techniques described previously may be used to integrate the chip. In a non-removable configuration, the chip may be molded or embedded in a handle or head portion. In a removable embodiment, a plug or tray may be configured to removably snap, slide, twist, friction fit, or otherwise be inserted into a corresponding recess of the brush or comb. The plug or tray is sized and shaped to securely hold the contactless payment chip, while also preferably being of a size and shape convenient for a consumer to easily handle.

It will be appreciated that the above figures and description provide exemplary, non-limiting configurations for the integration of a contactless payment chip into cosmetic packaging. Although the present invention has been described with reference to these exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A contactless payment product comprising:
a contactless payment chip contained in a portion of a cosmetic packaging.

2. The product of claim 1, wherein the contactless payment chip is removably contained in at least one of (i) a tray and (ii) a plug configured to removably fit within a corresponding recess in the cosmetic packaging.

3. The product of claim 2, wherein the tray and plug removably fit through one or more of snapping, sliding, twisting, screwing, and friction fitting in the corresponding recess.

4. The product of claim 1, wherein the contactless payment chip is non-removably contained in the portion of the cosmetic packaging.

5. The product of claim 4, wherein the contactless payment chip is non-removably contained by one of (i) being molded into the portion of the cosmetic packaging or (ii) being glued into a recess of the portion of the cosmetic packaging.

6. The product of claim 1, wherein the cosmetic packaging comprises one of a compact, a lipstick, a pen product, or an atomizer, and wherein the contactless payment chip is contained within one of a base portion or a lid portion of the compact, the lipstick, the pen product, or the atomizer.

7. The product of claim 1, wherein the cosmetic packaging comprises one of a bottle, a tube, a tottle, or an atomizer, and wherein the contactless payment chip is contained within a cap portion of the bottle, the tube, the tottle, or the atomizer.

8. The product of claim 1, wherein the cosmetic packaging comprises one of a lipstick, a bottle, an atomizer, or a brush, and wherein the contactless payment chip is contained within a recessed side portion of the lipstick, the bottle, the atomizer, or the brush.

9. The product of claim 1, wherein the contactless payment chip is configured to transact with one or more associated contactless payment readers.

10. The product of claim 1, wherein the cosmetic packaging comprises a container in which one or more cosmetic products are contained, wherein the container comprises one of a compact, a tube, a bottle, a tottle, and a pen.

11. The product of claim 10, wherein the one or more cosmetic products comprise one or more of powder, blush, bronzer, eye shadow, lipstick, lip gloss, mascara, concealer, cream, lotion, and fragrance.

12. A cosmetic package comprising:
one or more sidewalls; and
a contactless payment chip.

13. The cosmetic package of claim 12, wherein the contactless payment chip is affixed to the one or more sidewalls.

14. The cosmetic package of claim 13, wherein contactless payment chip is affixed to a removable tray or plug in the one or more sidewalls.

15. The cosmetic package of claim 13, wherein the contactless payment chip is permanently affixed to the one or more sidewalls.

16. The cosmetic package of claim 13, wherein the contactless payment chip is removably affixed to the one or more sidewalls.

17. The cosmetic package of claim 12, wherein the one or more sidewalls form a container in which one or more cosmetic products are contained, wherein the container comprises one of a compact, a tube, a bottle, a tottle, a pen, an atomizer, and a brush.

18. The cosmetic package of claim 17, wherein the one or more cosmetic products comprise one or more of powder, blush, bronzer, eye shadow, lipstick, lip gloss, mascara, concealer, cream, lotion, and fragrance.
